(19) United States
(12) Patent Application Publication
(10) Pub. No.: US 2023/0087593 A1
(43) Pub. Date: Mar. 23, 2023

(54) SEALING OF A TURBINE RING MADE OF A CERAMIC MATRIX COMPOSITE

(71) Applicant: SAFRAN CERAMICS, LE HAILLAN (FR)

(72) Inventors: Maxime François Roger CARLIN, MOISSY-CRAMAYEL (FR); Adèle LYPRENDI, MOISSY-CRAMAYEL (FR); Jean-François HENNE, MOISSY-CRAMAYEL (FR); Lisa PIN, MOISSY-CRAMAYEL (FR)

(21) Appl. No.: 17/802,062

(22) PCT Filed: Feb. 19, 2021
(86) PCT No.: PCT/FR2021/050303

§ 371 Date: Aug. 24, 2022

(30) Foreign Application Priority Data
Feb. 24, 2020 (FR) FR2001805

(51) Int. Cl. F01D 11/08; F01D 11/00; F01D 9/04

(52) U.S. Cl. CPC F01D 11/08; F01D 11/001; F01D 9/041; F05D 2240/11; F05D 2260/36; F05D 2300/2261; F05D 2300/6033

(57) ABSTRACT

Assembly in a turbine comprising: —at least one turbine ring made of a ceramic composite having a silicon carbide SiC matrix and fibers, the ring comprising a plurality of sectors (10) arranged circumferentially end to end, each of the ring sectors (10) comprises at least one circumferential edge (26, 28) provided with at least one slot (30a, 30b, 30c) opening circumferentially, —at least one sealing member being inserted for a first part into one of the slots (30a, 30b, 30c) of an edge of a first ring sector and for a second part into one of the slots (30a, 30b, 30c) of an edge of a second ring sector, circumferentially adjacent to the first ring sector, the assembly being characterized in that the sealing member is made of a ceramic matrix composite.

### TECHNICAL FIELD OF THE INVENTION

The present document relates to inter-sector sealing in a turbomachine.

### PRIOR ART

In order to reduce fuel consumption and reduce the carbon impact, one of the first solutions suggested is to reduce the mass of aircrafts. To this end, aircraft manufacturers are moving towards the use of composite materials having a density lower than that of conventionally used metallic materials.

The second solution allowing reducing fuel consumption is to increase the efficiency of turbojet engines, which implies an increase in the temperature of the combustion gases. Yet, metallic materials, and more particularly nickel- or cobalt-based alloys, currently used in turbomachines, reach their temperature limit so that an increase in the combustion temperature is not possible. Indeed, the thermostructural parts of turbomachines should have good mechanical properties in difficult environments: very high temperatures, high pressures, water vapour rich and oxidising atmospheres.

To provide a solution to the problem of mass and that of temperature, it is possible to use CMC materials. Ceramic material composites (CMC), having a density comprised between 2 and 3, have the advantage of being lighter than the higher density nickel or cobalt based alloys. The most advanced CMCs used to date are those formed by a matrix and fibres of silicon carbide SiC. Although these are made of fragile materials (matrix, fibre, interphase), CMCs are robust materials thanks to their structure and their architecture. Indeed, the interphase deposited over the fibre allows diverting the cracks while the matrix allows protecting the fibres and the interphases.

In a turbomachine, it is known to make the turbine distributors or the rings surrounding the annular rows of movable vanes in CMC with matrices and fibres in silicon carbide SiC (called SiC-based CMC later on). A distributor comprises an inner annular platform and an outer annular platform connected to each other by radial vanes. These platforms form rings just like the rings surrounding the annular rows of movable vanes. These rings are fastened to the metal casing in a manner well known to a person skilled in the art.

These ring sectors are arranged circumferentially end-to-end and sealing at the circumferential junction thereof is achieved by sealing members such as tabs which allows limiting inter-sector air leaks. Half of these metal tabs are inserted into a circumferential edge of a first ring sector and the other half into a circumferential edge of a second ring sector circumferentially adjacent to the first ring sector.

Conventionally, the tabs may be made of a nickel or cobalt alloy.

Many works have studied the reactivity between SiC and many metals including nickel Ni and cobalt Co. Indeed, nickel Ni and cobalt Co react with silicon to form brittle silicides which is accompanied by a precipitation of carbon in the form of graphitic sheets weakening the system (SiC-based CMC/Metal). In the presence of SiC, nickel or cobalt can give, depending on the silicon concentration and the temperature, Nickel or Cobalt silicides. This problem of reactivity is even more important as the system must operate at high temperature. Indeed, the high temperature promotes the growth of the reaction layer which causes an uncontrolled evolution of the chemistry, which is detrimental to the mechanical strength of the system. It has also been observed that many cracks could appear at the reactive interfaces which tends to weaken the system. Furthermore, under mechanical loading, these cracks in the matrix could form a privileged network for the propagation of oxidising species (O₂, H₂O) within the material. These oxidising species diffuse throughout the microcracks and deteriorate it by oxidation/corrosion. This affects the long-term durability of CMCs: these oxidation reactions modify the structural properties and considerably reduce their mechanical properties.

In other words, the metal alloy of the tab reacts with the CMC material based on silicon carbide SiC and gives silicides. These silicides modify the chemistry at the interface of the SiC-based CMC material, causing microcracks to appear through which oxidising molecules such as O₂ and H₂O could pass and oxidise, i.e. corrode the SiC-based CMC material. Metal alloys are also known to oxidise.

### DISCLOSURE OF THE INVENTION

To this end, the present document relates to an assembly in a turbine comprising:

at least one turbine ring made of ceramic material composite with a matrix and silicon carbide SiC fibres, the ring including a plurality of sectors, arranged circumferentially end-to-end, each of the ring sectors comprises at least one circumferential edge provided with at least one slot opening out circumferentially,

at least one sealing member being inserted for a first portion into one of said slots of an edge of a first ring sector and for a second portion into one of said slots of an edge of a second ring sector, circumferentially adjacent to the first ring sector, the assembly being characterised in that the sealing member is made of composite material with an oxide ceramic matrix.

Thus, in order to avoid the formation of these silicides, the sealing member conventionally made of metal based on Ni or Co of the prior art is replaced by CMCs.

Said sealing member may be made of a ceramic matrix composite material with an oxide matrix and fibres.

The CMC material with an oxide matrix and fibres (also called oxide CMC) is stable up to high temperatures, which allows avoiding oxidation/corrosion problems. Moreover, said sealing member made of oxide CMC has the property of being inert with regards to chemical interactions with silicon carbide SiC at high temperature, is airtight and mechanically compatible with the SiC-based CMC. Finally, the replacement of the metal alloy component by a member made of oxide CMC represents a net gain in mass thanks to the low density represented by this material and therefore a reduction in polluting emissions.

Said composite material of the sealing member may comprise alumina fibres and an alumino-silicate matrix. The sealing member may have a thickness smaller than 1 mm thick.

Oxide CMC is a material capable of being made in the form of plates a few tenths of a mm thick. This small thickness makes it all the more possible to guarantee sealing of the two ring sectors.

The sealing member may be a sealing member with a substantially planar shape. It could then be described as a tab.

This planarity facilitates sealing and, by its shape, limits air leaks.

The ring may externally surround an annular row of movable vanes and be carried by an outer casing.

Said assembly may comprise an annular row of stator vanes including an inner and outer annular platform, at least one amongst the inner and outer annular platforms being formed by said ring.

The sealing member may be arranged between two circumferential edges of two adjacent turbine ring sectors, said sealing member being characterised in that it is made of a ceramic matrix composite material.

The present document will be better understood and other details, features and advantages of the present document will appear upon reading the following description given as a non-limiting example with reference to the appended drawings.

### BRIEF DESCRIPTION OF THE FIGURES

FIG. 1 is a perspective view of a turbine ring.

FIG. 2 is a perspective view of a turbine distributor.

FIG. 3 is a perspective view of a sealing member according to the invention.

### DETAILED DESCRIPTION OF THE INVENTION

Conventionally in a turbomachine, a moving wheel of the turbine is externally surrounded by a support ring made of an abradable material. The ring is fastened to an outer casing and is formed by a plurality of sectors arranged circumferentially end-to-end.

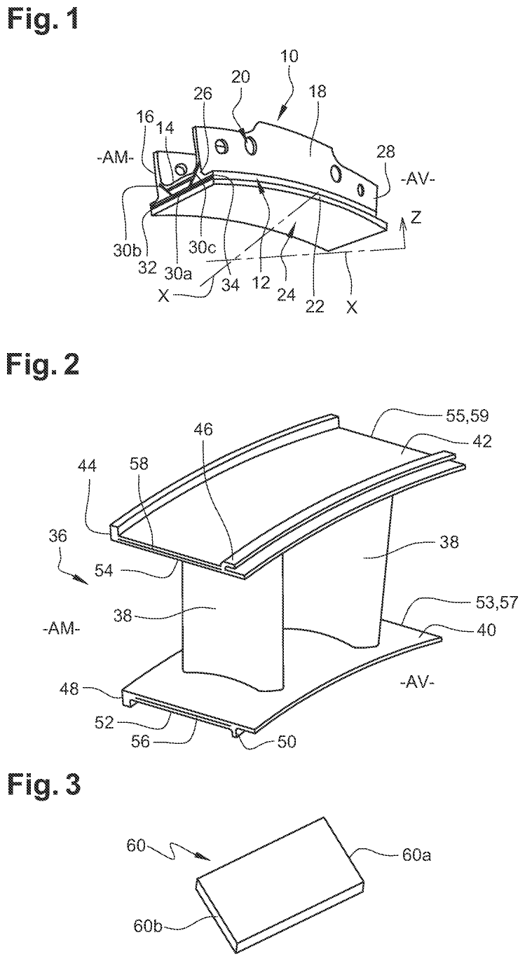

FIG. 1 illustrates such a ring sector 10 of a turbomachine turbine, the ring being made of CMC with a matrix and fibres of silicon carbide SiC. This ring sector 10 comprises an annular wall portion 12, herein cylindrical, including a radially outer face 14 from which extend, radially outwards, an upstream AM first radial annular wall 16 and a downstream AV second annular wall radial 18. The upstream first radial annular wall 16 and the downstream second radial annular wall 18 are provided with orifices 20 intended for fastening the ring sector 10 to the outer casing of the turbine by bolting. The ring sector 10 carries on a radially inner face 22 of the cylindrical annular wall portion 12, an abradable material layer 24 intended to cooperate with the radially outer ends of the vanes of the bladed movable wheel.

Each ring sector 10 has two circumferentially opposite edges 26, 28, facing a circumferential edge of an adjacent ring sector. Each circumferential edge 26, 28 of a ring sector 10 has at least one slot, where appropriate three slots 30a, 30b, 30c opening out circumferentially in the direction of an adjacent ring sector, and facing a slot of said adjacent ring sector.

In a particular embodiment, each circumferential edge 26, 28 comprises a first longitudinal slot 30a extending parallel to an axis X of rotation of the turbomachine.

The circumferential end 26, 28 also comprises second and third obliquely inclined slots 30b, 30c, extending according to a longitudinal component X and a radial component Z. The second and third slots 30b, 30c open out radially inwards in the first longitudinal groove 30a, and extend radially outwards at least partly across the thickness of the upstream 16 and downstream 18 radial annular walls. The second slot 30b and the third slot 30c depart from each other radially outwards. Thus, the second slot 30b extends towards an upstream edge 32, and the third slot 30c towards a downstream edge 34, of the ring sector 10.

These first, second and third slots 30a, 30b, 30c are intended to receive a sealing member 60 which, in the embodiment represented in FIG. 3, has a substantially planar shape. This sealing member may be described as a tab. Thus, these sealing tabs are inserted into the slots 30a, 30b, 30c at the circumferential ends 26, 28 of the ring sectors. The sealing tabs are partly inserted into the slots 30a, 30b, 30c of a circumferential end 26, 28 of a ring sector 10 and partly into the slots of the circumferential end of an adjacent ring sector. These sealing tabs allow guaranteeing sealing between two adjacent ring sectors 10.

FIG. 2 illustrates an example of a turbine distributor 36 sector. Conventionally, a distributor comprises an annular row of substantially radial vanes 38 connected at their radially inner ends by an inner annular platform or inner ring 40 and at their radially outer ends by an outer annular platform or outer ring 42. The distributor comprises several sectors 36 assembled circumferentially to each other, each sector 36 comprising several vanes 38 and an inner ring sector 40 or inner platform sector and an outer ring sector 42 or outer platform sector.

In a manner similar to what has been described with reference to FIG. 1, each inner 40 and outer 42 ring sector comprises two circumferential edges 52, 53, 54, 55 each including at least one slot 56, 58, two of which are not visible, into which sealing means such as tabs 60 are fitted. These tabs 60 are inserted partly into the slots 56, 57, 58, 59 of a circumferential end of an inner 40 or outer 42 annular platform sector and partly into the slots 56, 58 of the circumferential end of an inner 40 or outer 42 annular platform sector respectively. These also guarantee sealing between two sectors. Each of the inner 40 and outer 42 annular platform sectors forming a ring.

As indicated before, the sealing tabs are commonly made of a metallic material, more particularly a nickel- or cobalt-based alloy which, at high temperature, reacts with the CMC material of the ring sector 10, 40, 42. As indicated before, the use of tabs made of a metallic material poses difficulties in terms of silicide formation and oxidation.

According to the present document, it is suggested to make the tabs 60 in CMC and, more particularly, with a matrix and oxide fibres. Typically, the fibre is made of alumina and the matrix is made of alumino-silicate. The tab 60 has two circumferential edges 60a, 60b able to be inserted into said slots 30a, 30b, 30c, 56, 58.

Said tab 60 has a thickness of less than 1 mm thick and has a substantially planar shape. Indeed, because of the properties of oxide CMC, it is possible to make the tabs in the form of plates a few tenths of a mm thick. The total thickness thus being small, this makes sealing of the two ring sectors all the more easier. In turn, planarity also allows limiting air leaks.

1. An assembly in a turbine comprising:
at least one turbine ring made of ceramic material composite with a matrix and silicon carbide SiC fibres, the turbine ring including a plurality of ring sectors, arranged circumferentially end-to-end, each of the ring sectors comprises comprising at least one circumferential edge provided with at least one slot opening out circumferentially,
at least one sealing member comprising a first portion inserted into one of said slots of an edge of a first ring sector and a second portion inserted into one of said slots of an edge of a second ring sector, circumferentially adjacent to the first ring sector,
the assembly being characterised in that the sealing member is made of composite material with an oxide ceramic matrix.

2. The assembly according to claim 1, wherein the composite material of the sealing member comprises alumina fibres and an alumino-silicate matrix.

3. The assembly according to claim 1, wherein said sealing member has a thickness less than 1 mm thick.

4. The assembly according to claim 1, wherein the sealing member is a sealing member with a substantially planar shape.

5. The assembly according to claim 1, wherein the ring externally surrounds an annular row of moving vanes and is carried by an outer casing.

6. The assembly according to claim 1, wherein it comprises an annular row of stator vanes including inner and outer annular platforms, at least one amongst the inner and outer annular platforms being formed by said ring.

7. A sealing member intended to be arranged between two circumferential edges of two adjacent turbine ring sectors, said sealing member being characterised in that it is made of a ceramic matrix composite material.

8. The sealing member according to claim 7, wherein the two adjacent turbine ring sectors comprise a ceramic material composite with a matrix and silicon carbide SiC fibres, a plurality of ring sectors arranged circumferentially end-to-end to form a turbine ring, the two circumferential edges of the two adjacent turbine ring sectors comprising at least one slot opening out circumferentially, a first portion of the at least one sealing member inserted into one of said slots of an edge of a first ring sector and a second portion inserted into one of said slots of an edge of a second ring sector, circumferentially adjacent to the first ring sector.

9. The sealing member according to claim 8, wherein the turbine ring externally surrounds an annular row of moving vanes and is carried by an outer casing.

10. The sealing member according to claim 7, the ceramic matrix composite material of the sealing member comprising alumina fibres and an alumino-silicate matrix.

11. The sealing member according to claim 7, wherein said sealing member has a thickness less than 1 mm thick.

12. The sealing member according to claim 7, wherein the sealing member is a sealing member with a substantially planar shape.
